(19) United States
(12) Patent Application Publication
(10) Pub. No.: US 2006/0003287 A1
(43) Pub. Date: Jan. 5, 2006

(54) Tooth model for dental training and dental-training apparatus having the tooth model implanted therein

(75) Inventors: Kazuhisa Ose, Kameoka (JP); Satoru Funakoshi, Kameoka (JP)

Correspondence Address: KIRSCHSTEIN, OTTINGER, ISRAEL;& SCHIFFMILLER, P.C., 489 FIFTH AVENUE, NEW YORK, NY, 10017, US

(73) Assignee: NISSIN DENTAL PRODUCTS, INC., MINAMI-KU, KYOTO-SHI (JP)

(21) Appl. No.: 10/531,647

(22) PCT Filed: Oct. 10, 2003
(86) PCT No.: PCT/JP03/13097

§ 371 Date: Apr. 15, 2005

(30) Foreign Application Priority Data
Oct. 18, 2002 (JP) 2002-304193

(51) Int. Cl. A61C 19/00

(52) U.S. Cl. 433/74

(57) ABSTRACT

The present application is intended to provide a tooth model for dentistry practice and a dental practice device showing no deviation of tooth axis even after repeatedly attaching/detaching. At the side of the root of the tooth model for dentistry practice having a crown part 1 and a root part 2, a model tooth fixing part 3 which is made of a flexible synthetic material and has a column shape having a tooth axis 8 as the central axis is formed. At the bottom side, this fixing part has an enlarged part 7 enlarged outward around the tooth axis. This enlarged part is divided into smaller parts by dividing faces passing through the tooth axis and each division can deform toward the tooth axis. In this device for dentistry practice, the above-described tooth model is fixed into a fixing base 4 having a tooth fixing hole 5 capable of containing at least a part of the root part and the model tooth fixing part therein. Upon detachment, each divided part of the enlarged part bends toward the tooth axis and thus a locking part 6 provided in the tooth fixing hole and each divided part of the enlarged part is unlocked.

### TECHNICAL FIELD

The present invention relates to a model tooth (model tooth for dentistry practice) used by fixing on a fixing base at the time of various dentistry practices, and a device for dentistry practice comprising the model tooth and the fixing base for fixing the model tooth.

### BACKGROUND ART

Conventionally, a model tooth for dentistry practice is widely used in education fields of dental colleges and dental technicians' schools or the like. For example, a model tooth used by fixing to a model jaw is disclosed in Japanese Patent Publication (JP-B) No. 2506212. The model tooth is fixed to the jaw model as a model tooth base by pressing a leaf spring against a recessed part formed in a shank projected from a root part. Japanese Laid-Open Patent Publication (JP-A) No. 2002-628 discloses the model tooth which is fixed to the jaw model by providing a projection on the root part and fitting the projection of the root part to a dimple formed in the jaw model as the model tooth base.

However, in the model tooth disclosed in JP-B No. 2506212, the force of the leaf spring acts on the recessed part of the shank projected from the root part in one direction. Thereby, eccentric abrasion is caused in the root part, the shank or the model tooth base itself by repeating the attachment/detachment of the model tooth, resulting in the deviation of the tooth axis of the model tooth.

In the model tooth disclosed in JP-A No. 2002-628, the frictional force when fitting the projection formed on the root part to the dimple formed in the model tooth base acts in one direction. Thereby, eccentric abrasion is caused in the model tooth base and the root part by repeating the attachment/detachment of the model tooth, resulting in the deviation of the tooth axis of the model tooth.

The present inventors have conducted earnest studies for the model tooth having no deviation of the tooth axis of the model tooth even if the attachment/detachment of the model tooth is repeated so as to solve the aforementioned problems in the conventional model tooth for dentistry practice. As a result, apart (enlarged part) having a larger outer diameter is provided around the tooth axis as a central axis at the side of the root part of the model tooth, and the part has a structure (split pin structure) obtained by equally dividing the part to a plurality of divisions in a state that a space (clearance) having a constant width is formed by a plane extending from the tooth axis. In addition, the part is composed of an elastically deformable material. Thereby, each part equally divided can be moved toward the tooth axis of the model tooth, when the force is added from the outside direction. Accordingly, the present inventors have found that the deviation of tooth axis of the model tooth at the time of repeating the attachment/detachment of the model tooth can be effectively prevented, and the present invention was attained.

### DISCLOSURE OF THE INVENTION

The model tooth for dentistry practice of the present invention comprises
a crown part modeled by imitating a natural tooth,
a root part artificially modeled; and
a model tooth fixing part provided at the side of the root part of the model tooth, made of a bend elastic deformable synthetic resin material, located around the tooth axis of the model tooth as a central axis and being substantially small columnar,
the end side part of the model tooth fixing part having an enlarged part swelling in the outside direction around the tooth axis of the model tooth as a central axis,
at least the enlarged part of the model tooth fixing part divided into a plurality of divisions by a divided face directed outwardly from the tooth axis, whereby the divided enlarged parts (protuberant part) being respectively deformable toward the tooth axis of the model tooth.

In the model tooth for dentistry practice according to the present invention having the above structure, the synthetic resin material of which the model tooth fixing part is made has a bend elastic modulus of 800 MPa or more and less than 10000 MPa.

Further, the device for dentistry practice according to the present invention comprises
the model tooth for dentistry practice having the above structure; and
a model tooth fixing base in which the model tooth is inserted and fixed to the position of a tooth fixing hole formed therein in a state that the model tooth is detachably fitted,
the root part of the model tooth having a model tooth fixing part made of a bend elastic deformable synthetic resin material, located around the tooth axis of the model tooth as a central axis and being substantially small columnar,
the end side part of the model tooth fixing part having an enlarged part swelling in the outside direction around the tooth axis of the model tooth as a central axis,
at least the enlarged part of the model tooth fixing part divided into a plurality of divisions by a divided face directed outwardly from the tooth axis, whereby the divided enlarged parts being respectively deformable toward the tooth axis of the model tooth,
the tooth fixing hole formed in the model tooth fixing base having a shape suitable for accommodating at least a part of the root part of the model tooth and the model tooth fixing part, whereby the model tooth capable of being fixed by locking the enlarged part to a locking part formed on the inner wall surface of the tooth fixing hole at the time of inserting the model tooth into the tooth fixing hole, and the engagement of the locking part and the enlarged part being unlocked by the bend deformation of the divided enlarged parts toward the tooth axis at the time of pulling out the model tooth fixed to the tooth fixing hole.

### BRIEF DESCRIPTION OF THE DRAWINGS

FIG. 1 is a perspective view showing one example of the appearance shape of a model tooth for dentistry practice according to the present invention.

FIG. 2 is a sectional structure view showing one example of a state that the model tooth for dentistry practice of the present invention is fixed in a tooth fixing hole 5 of a jaw model 4 as a model tooth fixing base.

FIG. 3 is a sectional structure view showing one example of a state that the model tooth for dentistry practice of the present invention is fixed in the tooth fixing hole 5 of a holder 4′ for shape measurement as the model tooth fixing base.

FIGS. 4 (a) to (c) show specific examples of the shape of an enlarged part 7 formed on a model tooth fixing part 3 and a divided structure of the enlarged part in the model tooth according to the present invention.

FIGS. 5 (a) to (d) show sectional structures showing specific examples of the connection structure of the model tooth fixing part and root part according to the present invention.

### BEST MODE FOR CARRYING OUT THE INVENTION

Hereinafter, one example of a model tooth for dentistry practice of the present invention will be described with reference to schematic views.

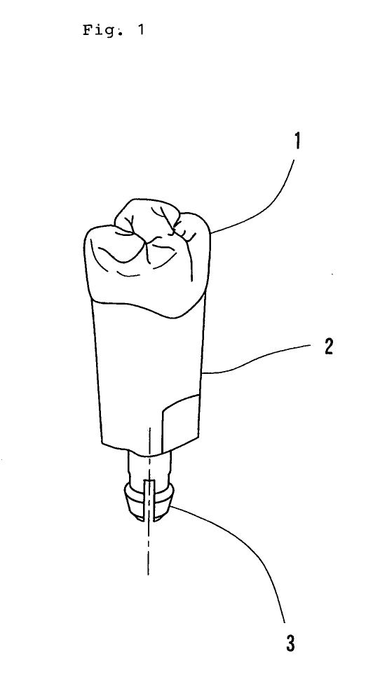

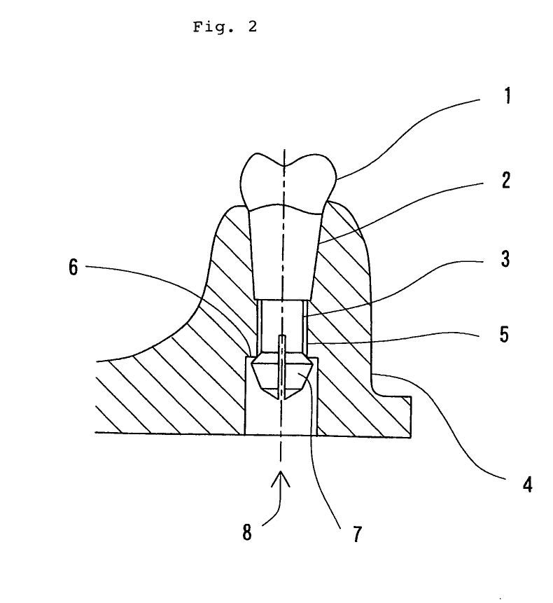

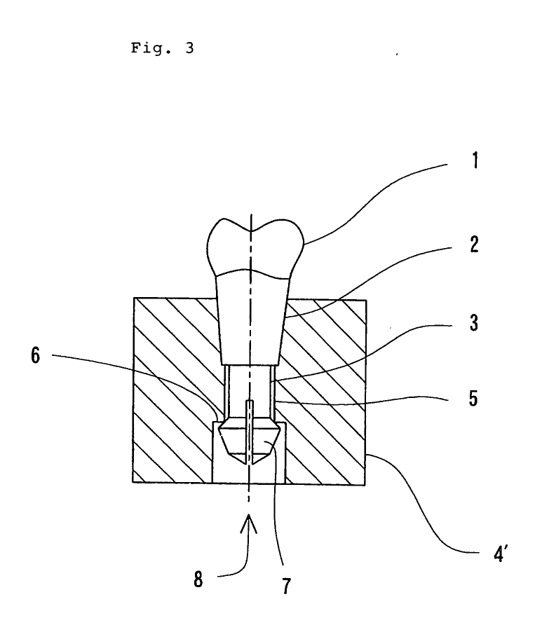

FIG. 1 shows the appearance of one example of a preferred model tooth for dentistry practice according to the present invention. This model tooth is composed of a crown part 1 modeled by imitating a natural tooth and formed of a single layer structure or a multilayer structure, a root part 2 artificially modeled, and a model tooth fixing part 3 projected from the end part of the root part, located around the tooth axis of the model tooth as a central axis and being substantially small columnar. This model tooth fixing part 3 is made of a bend elastic deformable synthetic resin material. For example, the model tooth for dentistry practice of the present invention is used for dentistry practice by inserting and fixing at least a part of the root part 2 and the model tooth fixing part 3 to a tooth fixing hole 5 of a jaw model 4 imitating a human gingiva shown in FIG. 2. Or, the model tooth is used by fixing to a tooth fixing hole 5 of a holder 4′ for shape measurement for measuring the outer shape of the model tooth shown in FIG. 3. The holder 4′ is a prismatic model tooth fixing fixing base for evaluating the result of cutting practice using a laser beam or the like, and the outer shape is measured by setting the fixing base to a measuring instrument. In FIGS. 2, 3, numeral 6 designates a locking part formed on the inner wall surface of the tooth fixing hole 5.

FIGS. 2, 3 show the structure of a device for dentistry practice of the present invention. In this device, the tooth fixing hole 5 formed in the model tooth fixing base has a shape suitable for accommodating at least a part of the root part 2 of the model tooth and the model tooth fixing part 3. The model tooth can be fixed by locking the enlarged part 7 to a locking part 6 formed on the inner wall surface of the tooth fixing hole 5 when the model tooth is inserted into the tooth fixing hole 5. The engagement of the locking part 6 and the enlarged part 7 is unlocked by the bend deformation of the divided enlarged parts 7 toward the tooth axis on the inside when the model tooth fixed to the tooth fixing hole 5 is pulled out.

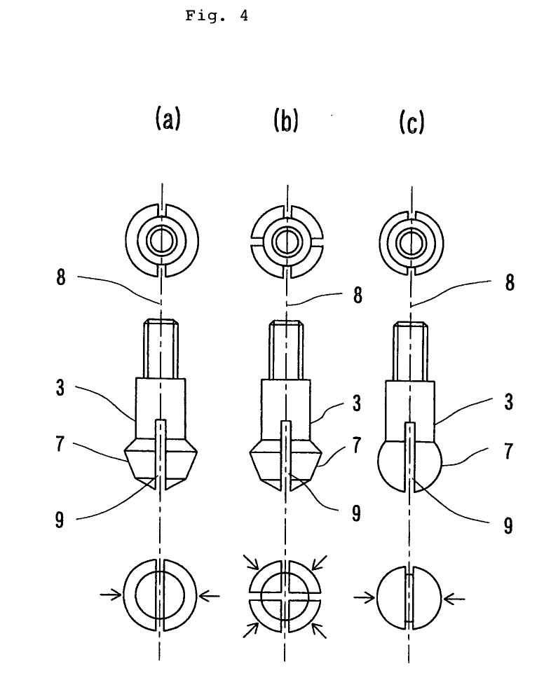

As shown in FIGS. 4 (a) to (c), in the model tooth for dentistry practice of the present invention, the end side part of the model tooth fixing part 3 has an enlarged part 7 swelling in the outside direction around the tooth axis 8 of the model tooth as a central axis. At least the enlarged part 7 of the model tooth fixing part 3 is divided into a plurality of divisions by a divided face directed outwardly from the tooth axis 8. That is, the enlarged part 7 is branched into a plurality of rod-like parts while maintaining the direction nearly equal to the direction of the tooth axis 8 of the model tooth from the end part of the model tooth. In this rod-like part, the divided enlarged parts (protuberant part) are respectively deformable toward the side of the tooth axis of the model tooth. In FIGS. 4 (a), (c), the enlarged part 7 is divided into two, and in FIG. 4 (b), the enlarged part 7 is divided into four. However, the number of divisions of the enlarged part 7 should never be limited thereto.

Particularly, the longitudinal sectional shape of the enlarged part 7 in the model tooth according to the present invention should never be limited thereto. The shape may be a circular, a semicircular, a sector having various central angles, a quadrangle, a triangle or a combination thereof. The longitudinal sectional shape can be suitably determined so as to fit to the tooth fixing hole formed in the fixing base. The length and outer diameter size in the tooth axis direction of the model tooth fixing part 3 are also suitably determined by the size of the model tooth, the fixing force required, or the shapes of the jaw model to which the model tooth is fixed and various holders or the like. The enlarged part 7 may be formed in a part of the outer side surface of each divided part of the model tooth fixing part 3, or may be entirely formed over the outer side surface.

In the present invention, as illustrated in FIGS. 4 (a) to (c), a space (clearance) 9 is respectively formed between the divided parts located adjacently in the divided parts (containing the enlarged part side of the columnar part of the model tooth fixing part 3) of the enlarged part 7 formed at the tip side of the model tooth fixing part 3. The space 9 is required for the deflection of the divided enlarged parts 7 in the tooth axis direction of the model tooth. At this time, as shown in FIGS. 4 (a) to (c), the space 9 may have a uniform distance with the adjacent divided parts in the tooth axis direction. The space of a root part may be narrowed, and the space may be larger as approaching the tip. The size of the space 9 is determined by the protuberant height of the enlarged part 7, more exactly the size of (the maximum outer diameter of the enlarged part 7 minus the minimum inner diameter of the locking part 6 formed in the tooth fixing hole 5 of the fixing base). The space must have a larger width than at least 2 times the above size. In the present invention, the above size is suitably determined by terms and conditions such as the shape, length and number of divisions of the model tooth fixing part 3 having the enlarged part 7, or the fixing intensity of the model tooth.

In the device for dentistry practice of the present invention, when the model tooth in which the above space 9 is formed is inserted into the tooth fixing hole 5 of the fixing base (model tooth base), the divided enlarged parts 7 are moved to the side of the tooth axis 8, and the space 9 is narrowed. When the divided enlarged parts 7 are located at the fixed position, one of the divided enlarged parts 7 is expanded so as to be in the original state or be almost equalized to the original state, and thereby the model tooth is fixed (see FIGS. 2, 3).

In the device for dentistry practice of the present invention, the pulling force when the model tooth is pulled from the model tooth fixing base is preferably 20 to 300 N, more preferably 30 to 150 N. When the pulling force is lower than 20 N, the model tooth is come off during the cutting practice of the model tooth or the scaling practice. When the pulling force is higher than 300 N, the exchange of the model tooth is disadvantageous. In order to satisfy these conditions, the size of the tooth fixing hole 5 to the model tooth fixing part 3 and enlarged part 7 of the present invention and the size relation of the locking part 6 are important.

When the protuberant height of the enlarged part 7 is too small, the sufficient fixing force is not acquired, and when the protuberant height is too large, the model tooth fixing part 3 and the enlarged part 7 are easily destroyed. Therefore, the maximum protuberant height of the enlarged part 7 is preferably about 5% to about 50% of the outer diameter of the model tooth fixing part 3, and more preferably 10 to 30%. The size of the tooth fixing hole 5 must have a size allowing the pass of the enlarged part 7 provided on the end part of the model tooth fixing part 3. However, when the size of the tooth fixing hole 5 is too large, the fixing force of the model tooth is not sufficiently acquired. When the size is too small, the tooth fixing hole 5, the locking part 6 or the model tooth fixing part 3 is easily destroyed. Herein, it is preferable that the size of the enlarged part provided on the model tooth fixing part 3 is about 30 to about 90% of the height direction of the tooth fixing hole 5 and the enlarged part just has to be locked by a locking part 6.

The locking part 6 and at least a part of the enlarged part 7 must be locked in a constantly contact state. When the locking part 6 does not come into contact with the enlarged part 7, the model tooth cannot be surely fixed to the model tooth fixing base. Therefore, it is necessary to make the length of the tooth fixing hole 5 a little longer than that of the model tooth fixing part 3, and make the length of the tooth fixing hole 5 shorter than that reaching the maximum protuberant part of the enlarged part 7.

Known materials shown below can be generally used for the crown part 1 and the root part 2 in the model tooth for dentistry practice of the present invention. For example, it is possible to use porcelains such as ceramics; thermoplastic synthetic resin materials such as acrylics, polystyrene, polycarbonate, an acrylonitrile styrene butadiene copolymer, polypropylene, polyethylene and polyester; thermosetting synthetic resin materials such as melamine, urea, unsaturated polyester, phenol and epoxy; one obtained by adding various additive agents (various organic and inorganic reinforced fibers such as glass fibers, carbon fibers, pulp and synthetic resin fibers; various fillers such as talc, silica, mica, calcium carbonate, barium sulfate and alumina; colorants such as pigment and dye; weather-resistant agents; and antistatic agents) to these main materials.

The various synthetic resin materials described above can be used for the material of the model tooth fixing part 3. However, the divided parts of the model tooth fixing part 3 have a moderate elastic property, and the divided parts must be bent in the directions of arrows as shown in FIGS. 4 (a) to (c). Also, the divided part must be repelled in the direction opposite to the arrows. Therefore, it is preferable that the synthetic resin material constituting the model tooth fixing part 3 has a bend elastic modulus of 800 MPa or more and less than 10000 MPa, particularly preferably 2500 MPa or more and less than 7000 MPa. In this case, when the bend elastic modulus of the synthetic resin material is too lower than the above lower limit, the sufficient fixing force cannot be obtained at the time of fixing the model tooth. Conversely, when the bend elastic modulus of the synthetic resin material is too higher than the above upper limit, the penetration hole part of the jaw model and various holders in which the model tooth is fixed is easily destroyed. The value of the bend elastic modulus which is specified in the present invention is measured according to ASTM-D790 at the measuring temperature of 23° C.

The model tooth fixing part 3 may be integrally formed with the root part 2 of the model tooth in the present invention. However, it is preferable that the model tooth fixing part 3 can be detached from or attached to the root part 2 such that the model tooth fixing part 3 can be exchanged when the enlarged part 7 of the model tooth fixing part 3 is worn out.

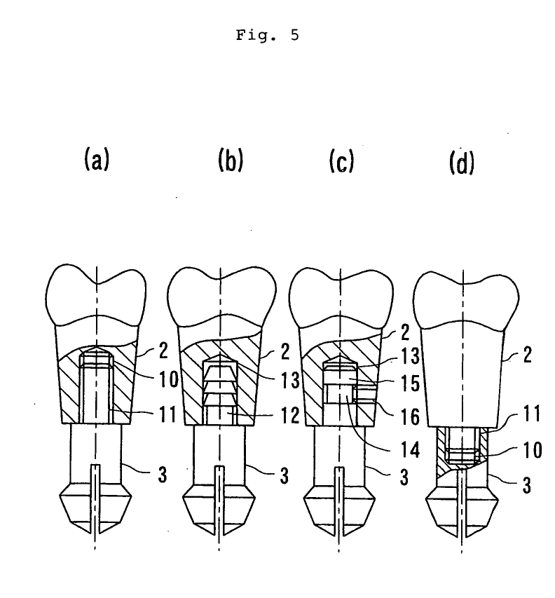

FIGS. 5 (a) to (d) show the longitudinal sectional structures of the model teeth at the time of connecting the model tooth fixing part 3 with the root part 2. For example, as shown in FIG. 5 (a), a screw hole 10 may be formed in the root part 2, and a screw 11 may be provided on the model tooth fixing part 3. Thereby, the model tooth fixing part 3 can be screwedly fixed to the screw hole 10 of the root part 2. Or, on the contrary, as shown in FIG. 5 (d), the screw hole 10 may be formed in the model tooth fixing part 3, and thereby, the screw 11 provided on the root part 2 can be screwedly fixed to the screw hole 10 of the model tooth fixing part 3. As shown in FIG. 5 (b), a recess-projection shaft 12 in which the outer diameter of a small column body is changed and which is provided on the upper part of the model tooth fixing part 3 may be press-fitted to the fixing hole 13 formed in the root part 2. As shown in FIG. 5 (c), a circumferential groove 14 may be formed along the outer periphery on the outer peripheral surface of a shaft body 15 provided on the upper part of the model tooth fixing part 3. After the shaft body 15 is inserted into a fixing hole 13 formed in the root part 2, a fixing screw 16 is screwed so as to be aligned with the position of the circumferential groove 14 formed on the shaft body 15 from the side surface of the root part 2, thereby the fixation of the model tooth fixing part 3 can be attained.

Although the method for forming the crown part 1 and root part 2 of the model tooth is suitably selected by the material to be used, for example, known techniques such as a conventional injection molding method and a conventional press molding method can be applied at the time of using the synthetic resin as the main materials. Even when the model tooth fixing part 3 is manufactured, the above known injection molding method and press molding method can be used, or the resin material can be cut by using a lathe and a milling machine or the like.

### EXAMPLE

The model tooth having the model tooth fixing part as shown in FIG. 5 (a) was produced as the model tooth for dentistry practice according to the present invention. The model tooth fixing part is formed of a cylinder having a diameter of 3.5 mm and a length of 5 mm, and the tip of the model tooth fixing part is provided with the enlarged part having a protuberant height of 0.5 mm (14.3% of outer diameter of the model tooth fixing part). The enlarged part is expanded at the angle of 45 degrees to the maximum protuberant part of the enlarged part from the model tooth fixing part having a diameter of 3.5 mm, and the protuberant becomes gently smaller toward the tip from the maximum protuberant part. The enlarged part has a length of 4 mm, and the enlarged part is divided into two by a space having a depth of 5 mm from the tip and a width of 1 mm. The model tooth fixing part is fixed to the root part of the model tooth by a screw embedded. The model tooth fixing part was formed by injection molding using glass fiber reinforced polycarbonate having a bend elastic modulus of 3530 MPa.

The model tooth was attached to the jaw model having the sectional structure as shown in FIG. 2. The hole diameter of the tooth fixing hole formed in this jaw model was set to 3.9 mm, and the length thereof was set to 5.3 mm. At this time, the enlarged part of 60% in the height direction is locked by the locking part. The jaw model was made of a material containing epoxy resin as a main component.

As a result of measuring the pulling force of model tooth of the model tooth for dentistry practice, the pulling force was 5N, and it was possible to perform cutting practice for the model tooth and scaling practice well. The pulling force was measured by using a tensile test device (trade name: AG-I-5kN) manufactured by Shimadzu Corporation. The jaw model and the model tooth were respectively fixed, and the pulling force was set to the maximum load when pulling at a test rate of 20 mm/min.

### INDUSTRIAL APPLICABILITY

The uneven abrasion of the model tooth and model tooth base can be prevented by using the model tooth for dentistry practice of the present invention having the model tooth fixing part. The model tooth can certainly be fixed to the model tooth fixing base without deviating the tooth axis of the model tooth.

Thus, the device for dentistry practice of the present invention in which the model tooth is steadily fixed to the model tooth fixing base is very suitable for performing various dentistry practices (medical treatment practice and cutting practice). In addition, the device has a structure in which the model tooth can be exchanged, and thereby the device has an advantage that the device can be repeatedly used.

1. A model tooth for dentistry practice which comprises
a crown part modeled by imitating a natural tooth,
a root part artificially modeled; and
a model tooth fixing part provided at the side of the root part of the model tooth, made of a bend elastic deformable synthetic resin material, located around the tooth axis of the model tooth as a central axis and being substantially small columnar,
the end side part of the model tooth fixing part having a huge part swelling in the outside direction around the tooth axis of the model tooth as a central axis,
at least the huge part of the model tooth fixing part divided into a plurality of divisions by a divided face directed outwardly from the tooth axis, whereby the divided huge parts being respectively deformable toward the tooth axis of the model tooth,
and in which the synthetic resin material of which the model tooth fixing part is made has a bend elastic modulus of 800 MPa or more and less than 10000 MPa.

2. (canceled)

3. A device for dentistry practice which comprises
a model tooth including a crown part modeled by imitating a natural tooth and a root part artificially modeled; and
a model tooth fixing base in which the model tooth is inserted and fixed to the position of a tooth fixing hole formed therein in a state that the model tooth can be detachably fitted,
the root part of the model tooth having a model tooth fixing part made of a bend elastic deformable synthetic resin material, located around the tooth axis of the model tooth as a central axis and being substantially small columnar,
the end side part of the model tooth fixing part having a huge part swelling in the outside direction around the tooth axis of the model tooth as a central axis,
at least the huge part of the model tooth fixing part divided into a plurality of divisions by a divided face directed outwardly from the tooth axis, whereby the divided huge parts being respectively deformable toward the tooth axis of the model tooth,
the tooth fixing hole formed in the model tooth fixing base having a shape suitable for accommodating at least a part of the root part of the model tooth and the model tooth fixing part, whereby the model tooth capable of being fixed by locking the huge part to a locking part formed on the inner wall surface of the tooth fixing hole at the time of inserting the model tooth into the tooth fixing hole, and the engagement of the locking part and the huge part being unlocked by the bend deformation of the divided huge parts toward the tooth axis at the time of pulling out the model tooth fixed to the tooth fixing hole, and in which the synthetic resin material of which the model tooth fixing part is made has a bend elastic modulus of 800 MPa or more and less than 10000 MPa.

4. The device for dentistry practice according to claim 3, in which the maximum protuberant height of the enlarged part is 5% to 50% of the outer diameter of the model tooth fixing part, and 30 to 90% of the maximum protuberant height of the enlarged part is engaged to the locking part, whereby the model tooth is fixed.
